(19) United States
(12) Patent Application Publication
(10) Pub. No.: US 2026/0221685 A1
(43) Pub. Date: Jul. 30, 2026

(54) CONNECTOR

(71) Applicant: JAPAN AVIATION ELECTRONICS INDUSTRY, LIMITED, Tokyo (JP)

(72) Inventors: Ryosuke FUKITA, Tokyo (JP); Yoshinobu YAMAMOTO, Tokyo (JP)

(73) Assignee: JAPAN AVIATION ELECTRONICS INDUSTRY, LIMITED, Tokyo (JP)

(21) Appl. No.: 19/424,471

(22) Filed: Dec. 18, 2025

(30) Foreign Application Priority Data
Jan. 27, 2025 (JP) 2025-011239

(51) Int. Cl. H01R 13/432; H01R 13/50

(52) U.S. Cl. CPC H01R 13/432; H01R 13/50

(57) ABSTRACT

A pressing piece is formed on an upper surface of the accommodating hole of the housing, and a protrusion is formed on a lower surface. The retainer includes a protruding portion, and when the retainer is at a first position, the box-shaped portion is allowed to be inserted into the accommodating hole, and the box-shaped portion inserted in the accommodating hole is pushed by the pressing piece and displaced in the intersecting direction so that a primary locking state is reached due to a projecting portion that is provided on the insertion direction side of the step portion in a manner protruding in an opposite direction from the insertion direction being caught by the protrusion and engaged and retained by a recessed portion formed on the protrusion and a rear end of the box-shaped portion being caught and retained by the protruding portion.

### TECHNICAL FIELD

The present disclosure relates to a connector structured to be able to achieve two states, namely, a primary locking state where a terminal is temporarily locked, and a secondary locking state where the terminal is fully locked.

### BACKGROUND ART

FIG. 1 shows a configuration of a conventional example of this type of connector described in Patent Literature 1. In FIG. 1, A is a cross-sectional view showing a terminal being inserted, B is a cross-sectional view showing a primary locking state of the terminal, and C is a cross-sectional view showing a secondary locking state of the terminal.

The connector disclosed in Patent Literature 1 includes a terminal 50A including a box-shaped portion 51A into which a mating terminal is to be inserted, a housing 40A including an accommodating hole 41A for accommodating the box-shaped portion 51A, and a retainer 60A capable of being at a first position and a second position by being attached to the housing 40A in a manner capable of being displaced in an intersecting direction intersecting with a direction of insertion of the box-shaped portion 51A into the accommodating hole 41A. A pressing piece 43A is formed on an upper surface of the accommodating hole 41A in a manner protruding toward a lower surface, and a protrusion 44A is formed on the lower surface in a manner protruding toward the upper surface, and the retainer 60A includes a protruding portion 69A (not shown) protruding on an extension of the accommodating hole 41A. When the retainer 60A is at the first position, the box-shaped portion 51A is allowed to be inserted into the accommodating hole 41A, and the box-shaped portion 51A inserted in the accommodating hole 41A is pushed by the pressing piece 43A and displaced in the intersecting direction so that the primary locking state is reached due to a step portion 56A of the box-shaped portion 51A being caught and retained by the protrusion 44A and a rear end of the box-shaped portion 51A being caught and retained by the protruding portion 69A. With the connector of Patent Literature 1 (Japanese Patent Application Laid Open No. 2024-75244), even when being pulled while being vertically shaken, the terminal is caught in the hole, and a locked posture of the terminal can be made stable.

### SUMMARY OF THE INVENTION

With the conventional connector described above, a holding force of primary locking of the terminal is higher than in a conventional case, and even if an electric wire connected to the terminal in the primary locking state is swung, for example, the terminal does not come off, and the primary locking state is maintained. For example, even if an electric wire 80A is swung downward and a state is reached where locking by the protrusion 44A is released, locking by a protruding portion 72A of the retainer 60A is maintained.

However, recently, there is a demand to further reduce the size of a connector, and a terminal that is an internal component of a connector is becoming more and more miniaturized. However, from the standpoint of connection reliability, the same performance as in a conventional case is desired to be maintained with respect to holding force of primary locking and secondary locking of the terminal.

The present disclosure is for solving the problem described above, and is aimed at providing a connector where stable terminal holding force can be secured even for a miniaturized terminal.

To solve the problem described above, a connector according to the present disclosure includes a terminal that includes a box-shaped portion to which a mating terminal is inserted and connected and that is attached to an end of an electric wire, a housing that includes an accommodating hole for accommodating the box-shaped portion, and a retainer that is capable of being at a first position and a second position by being attached to the housing in a manner capable of being displaced in an intersecting direction intersecting with an insertion direction of the box-shaped portion into the accommodating hole. When inner surfaces of the accommodating hole of the housing that face each other are given as an upper surface and a lower surface, a pressing piece having a cantilever shape is formed on the upper surface in a manner protruding toward the lower surface, and a protrusion is formed on the lower surface in a manner protruding toward the upper surface. The retainer includes a protruding portion that protrudes in the intersecting direction, on an extension of the accommodating hole, and when the retainer is at the first position, the box-shaped portion is allowed to be inserted into the accommodating hole, and the box-shaped portion inserted in the accommodating hole is pushed by the pressing piece and displaced in the intersecting direction so that a primary locking state is reached due to a projecting portion that is a part of a step portion formed on the box-shaped portion and that is provided on the insertion direction side of the step portion in a manner protruding in an opposite direction from the insertion direction being caught by the protrusion and engaged and retained by a recessed portion formed on the protrusion and a rear end of the box-shaped portion being caught and retained by the protruding portion.

### Effects of the Invention

With the connector of the present disclosure, even when being pulled while being vertically shaken, the terminal is caught in the recessed portion, and a locked posture of the terminal can be stabilized, and thus, stable terminal holding force can be secured even for a miniaturized terminal.

### BRIEF DESCRIPTION OF THE DRAWINGS

FIG. 1 is diagram showing a configuration of a conventional example of a connector described in Patent Literature 1;

A of FIG. 2 is a perspective view showing an example of a connector of the present disclosure from above, and B of FIG. 2 is a perspective view showing the example of the connector of the present disclosure from below;

FIG. 3 is an exploded perspective view of the connector shown in A of FIG. 2, where illustration is simplified and only one terminal is shown;

FIG. 4 is an exploded perspective view of the connector shown in B of FIG. 2, where illustration is simplified and only one terminal is shown;

A of FIG. 5 is a perspective view showing a terminal attached to an end of an electric wire, B of FIG. 5 is a side view thereof, and C of FIG. 5 is a cross-sectional view thereof;

A of FIG. 6 is a top view showing a distal end part of a box-shaped portion of the terminal from a first upper plate portion side, and B of FIG. 6 is a perspective view showing the distal end part of the box-shaped portion of the terminal from a projecting portion side;

A of FIG. 7 is a right side view of the distal end part of the terminal shown in A of FIG. 6, B of FIG. 7 is a left side view thereof, and C of FIG. 7 is a D-D cross-sectional view thereof;

A of FIG. 8 is a perspective view showing the connector before attachment of the terminal from above, and B of FIG. 8 is a perspective view showing the connector before attachment of the terminal from below;

FIG. 9 is a rear view of the connector when the terminal is being inserted, where illustration is simplified and only one terminal is shown;

A of FIG. 10 is an A-A cross-sectional view in FIG. 9, showing a state where the terminal is being inserted, B of FIG. 10 is the A-A cross-sectional view in FIG. 9, showing a primary locking state of the terminal, and C of FIG. 10 is the A-A cross-sectional view in FIG. 9, showing a secondary locking state of the terminal;

A of FIG. 11 is a B-B cross-sectional view in FIG. 9, showing a state where the terminal is being inserted, B of FIG. 11 is the B-B cross-sectional view in FIG. 9, showing the primary locking state of the terminal, and C of FIG. 11 is the B-B cross-sectional view in FIG. 9, showing the secondary locking state of the terminal;

A of FIG. 12 is an enlarged view of a distal end part of the terminal in C of FIG. 10, and B of FIG. 12 is an enlarged view of the distal end part of the terminal in C of FIG. 11;

A of FIG. 13 is a side view of the connector in a state shown in A of FIG. 11, B of FIG. 13 is an E-E cross-sectional view in A of FIG. 13, C of FIG. 13 is a side view of the connector in a state shown in C of FIG. 11, and D of FIG. 13 is an F-F cross-sectional view in C of FIG. 13;

A of FIG. 14 is a cross-sectional view showing a state where, in the cross-section shown in B of FIG. 10, the electric wire is swung downward and the terminal is tilted, and B of FIG. 14 is cross-sectional view showing a state where, in the cross-section shown in B of FIG. 11, the electric wire is swung downward and the terminal is tilted; and

A of FIG. 15 is a cross-sectional view showing a state where, in the cross-section shown in B of FIG. 10, the electric wire is swung upward and the terminal is tilted, and B of FIG. 15 is cross-sectional view showing a state where, in the cross-section shown in B of FIG. 11, the electric wire is swung upward and the terminal is tilted.

### DETAILED DESCRIPTION OF THE EMBODIMENTS

An embodiment of the present disclosure will be described based on an example and with reference to the drawings.

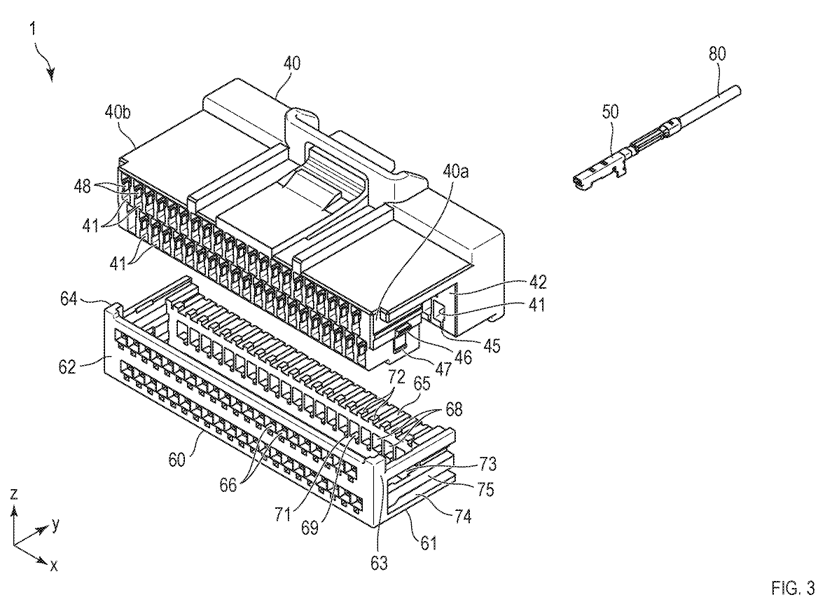

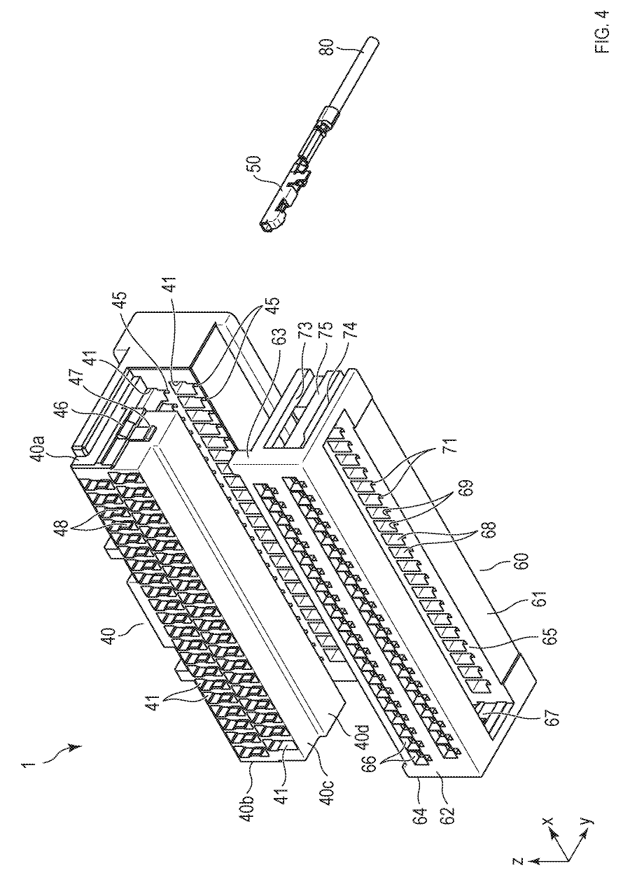

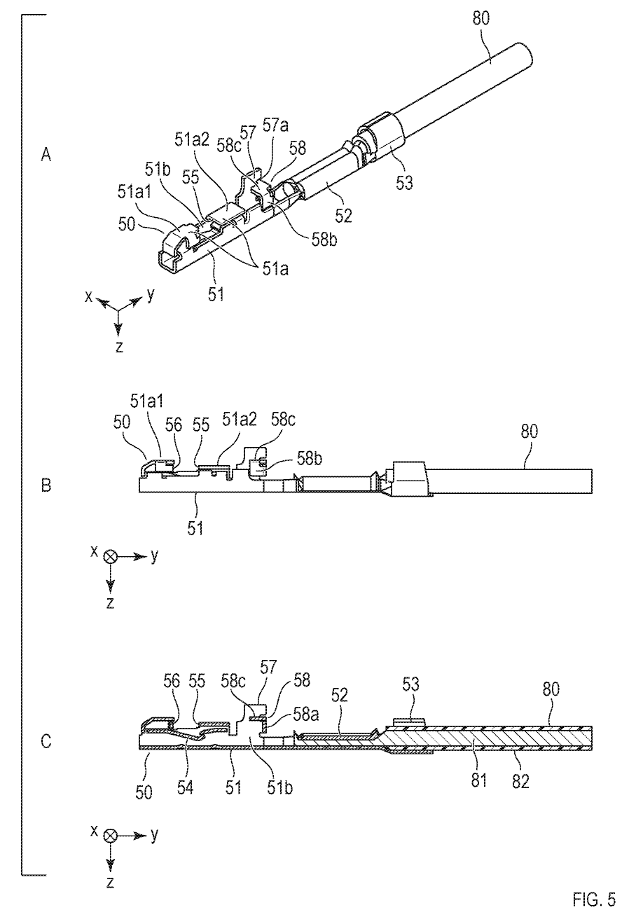

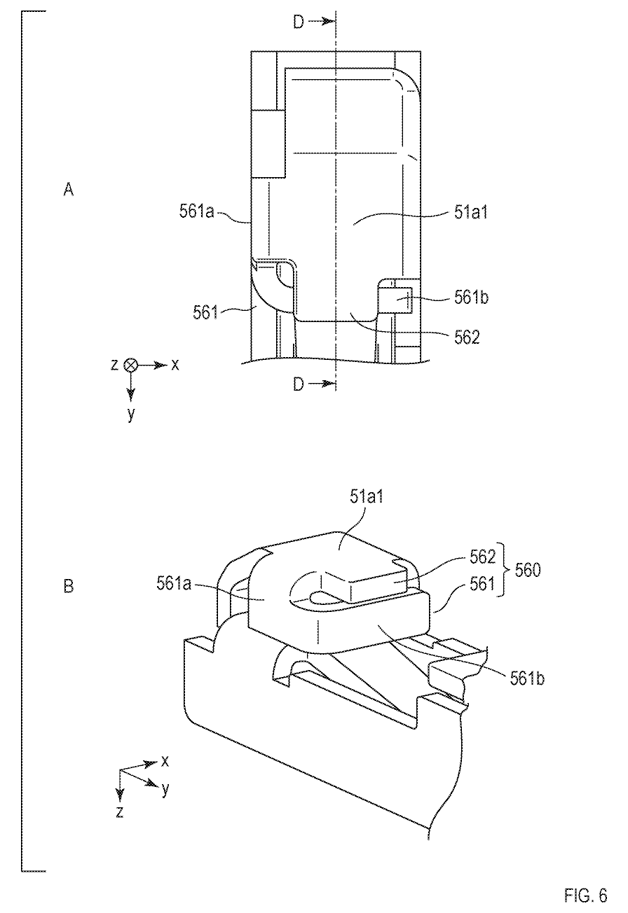

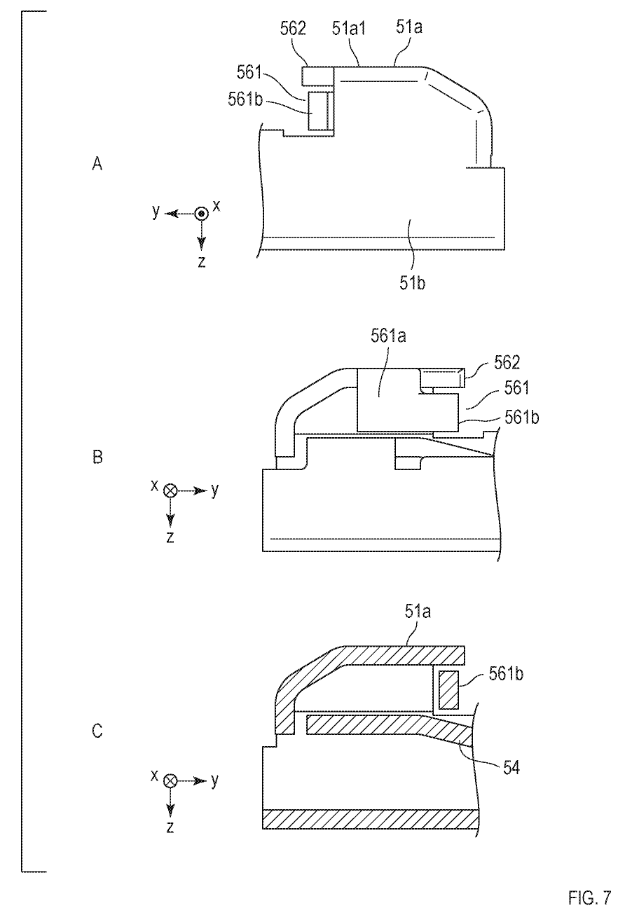

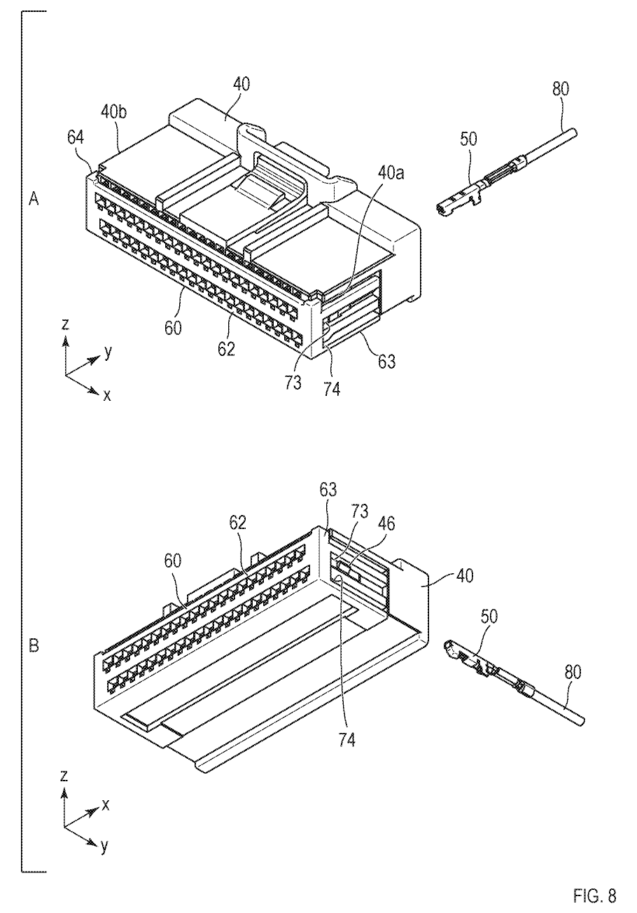

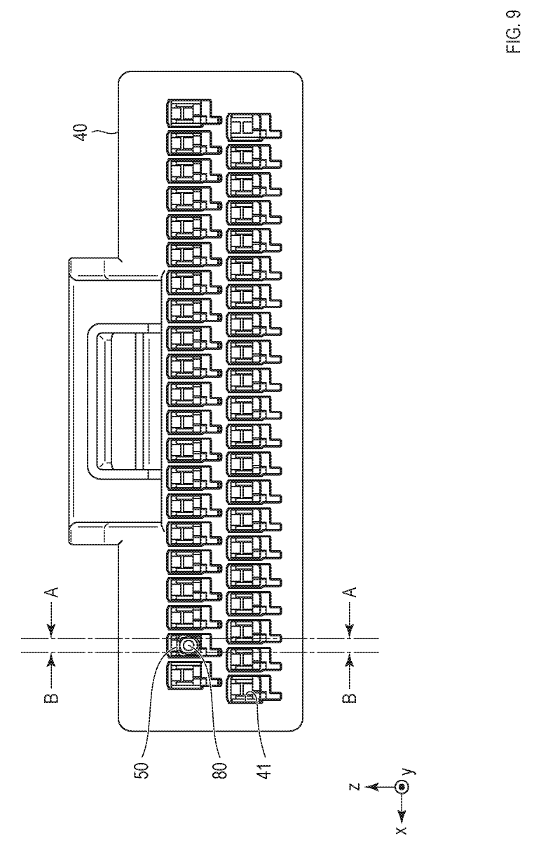

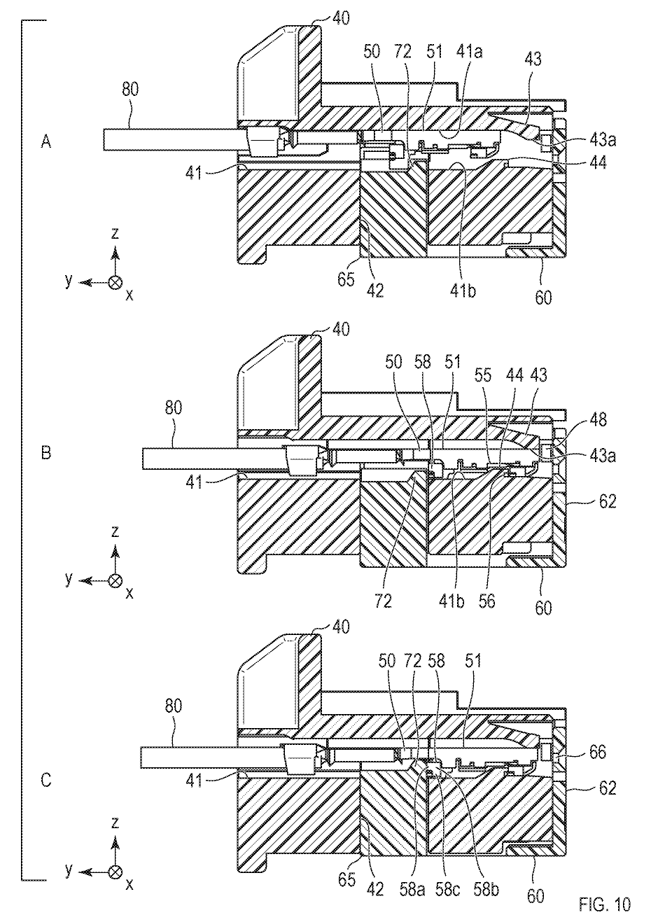

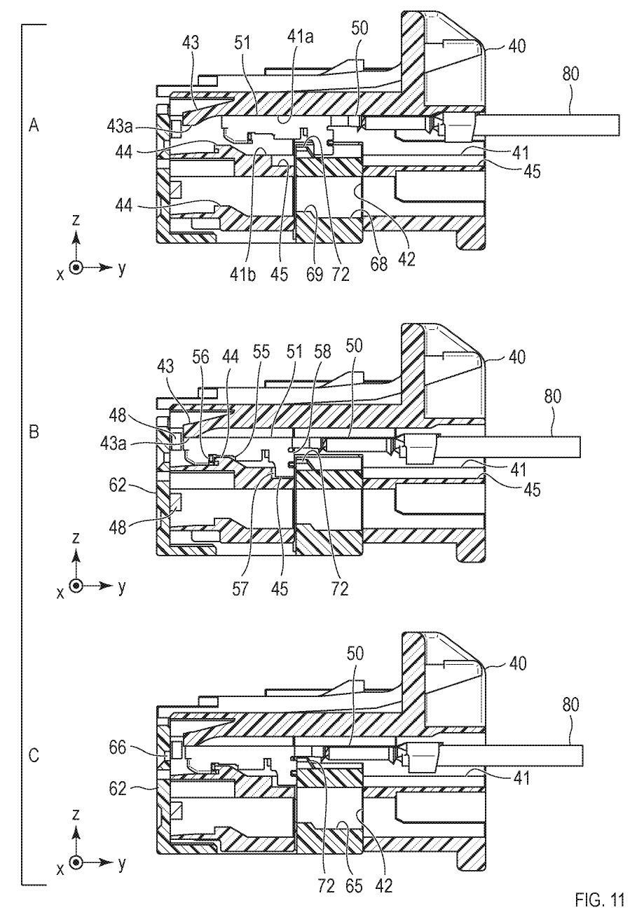

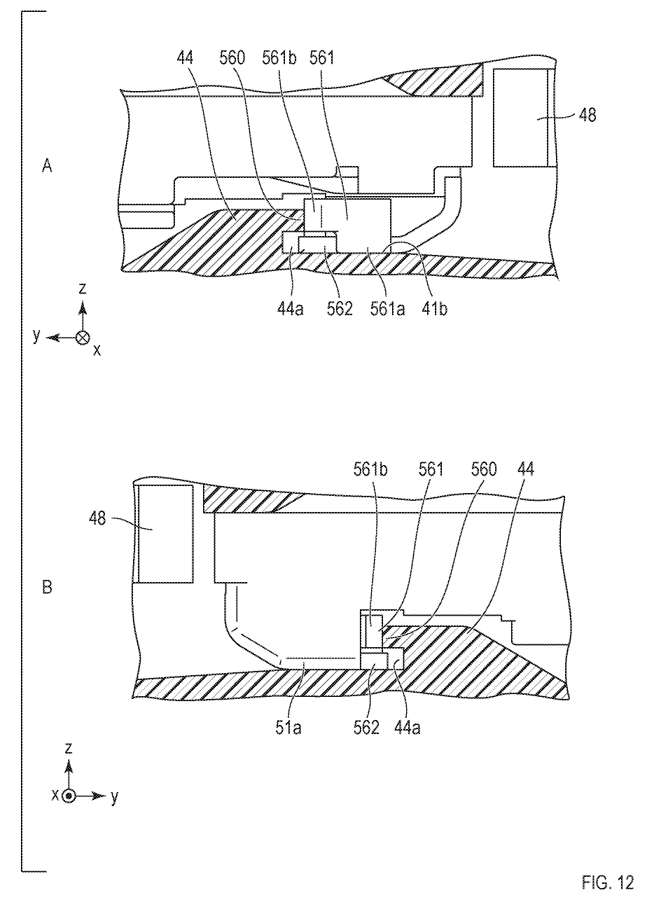

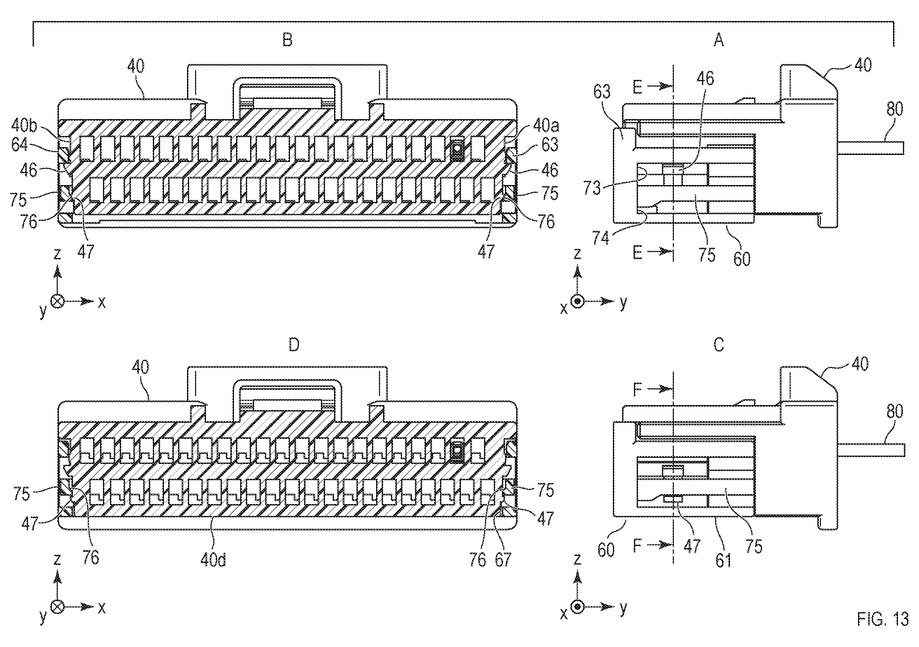

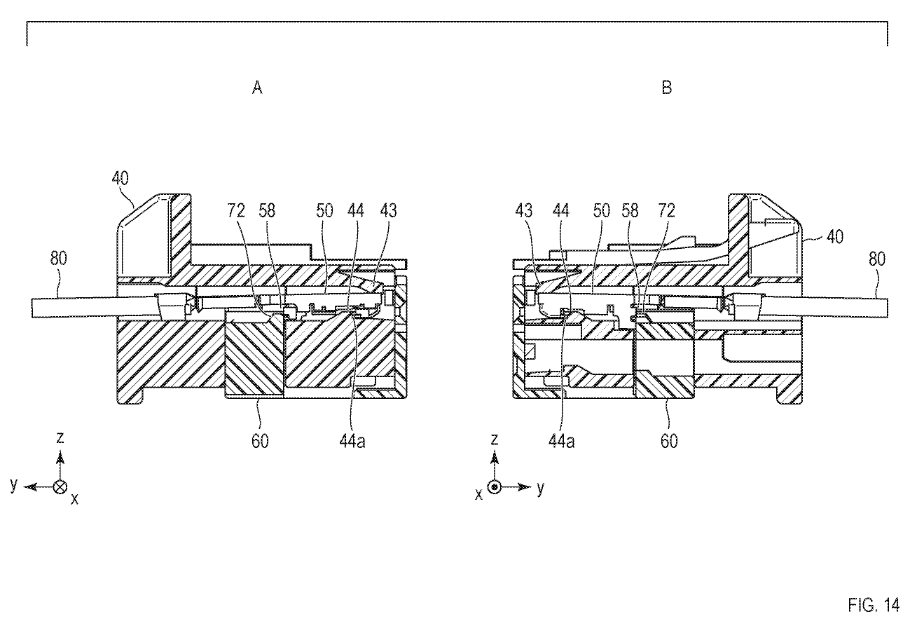

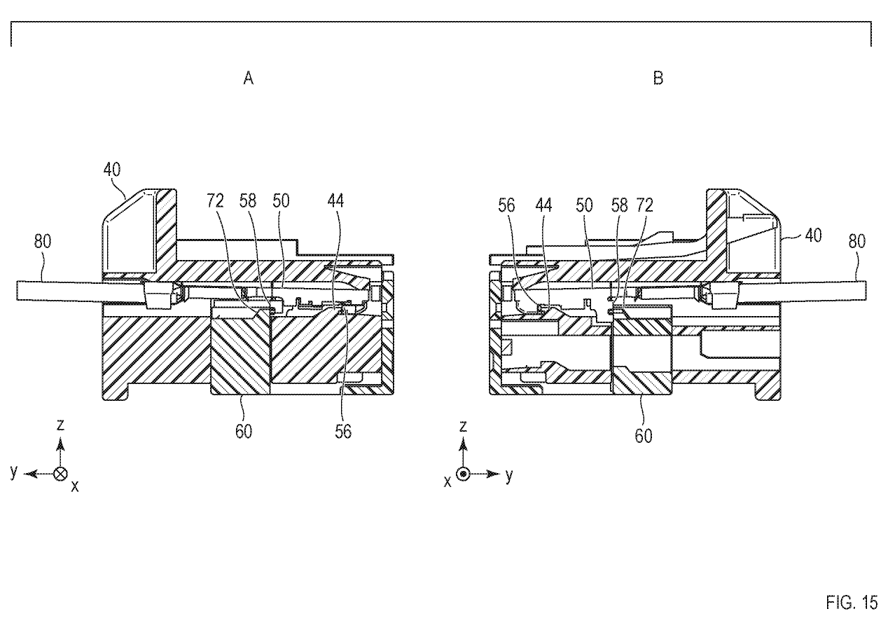

FIG. 2 shows an example of a connector of the present disclosure, and FIGS. 3 and 4 show the connector shown in FIG. 2 in an exploded manner. In the present example, a connector 1 includes a housing 40 made of resin, a large number of terminals 50, and a retainer 60 made of resin. In FIG. 2, 80 denotes an electric wire that is connected to the terminal 50. Furthermore, FIGS. 3 and 4 shown only one terminal 50 attached to an end of the electric wire 80, and illustration of other terminals 50 is omitted.

As shown in FIGS. 3 and 4, the housing 40 has a block shape, and a large number of accommodating holes 41 are formed in a manner penetrating in a front-back direction. The accommodating holes 41 are rectangular holes, and in the present example, the accommodating holes 41 are arranged in two rows, namely, an upper row and a lower row, in a staggered pattern. A recessed portion 42 is formed across a lower surface of the housing 40 in a left-right direction (width direction), and each accommodating hole 41 is divided into two parts, namely, a front part and a rear part, across the recessed portion 42.

A pressing piece 43 and a protrusion 44 (see FIGS. 10 and 11 described later) are formed on upper and lower surfaces that face each other and that are inner surfaces on a front end side of each accommodating hole 41. The pressing piece 43 is formed on an upper surface 41a of the accommodating hole 41 in a cantilever manner with a free end 43a protruding toward a lower surface 41b, and the free end 43a is positioned at a front end of the accommodating hole 41, and a base end is at a deeper position than the front end of the accommodating hole 41. The protrusion 44 is formed on the lower surface 41b of the accommodating hole 41 in a manner protruding toward the upper surface 41a, and is formed at a position facing the base end side of the pressing piece 43. Furthermore, a recessed portion 44a (see FIG. 12 described later) is formed on a front plate portion 62 side of the protrusion 44, the recessed portion 44a facing an opposite direction from an insertion direction of a box-shaped portion 51 described later. Additionally, a narrow groove 45 is formed in a corner portion of the lower surface 41b of each accommodating hole 41 in a manner extending in an extending direction of the accommodating hole 41. The groove 45 is formed in a manner extending from a rear end of the accommodating hole 41 across the recessed portion 42 to be slightly positioned in the accommodating hole 41 that is positioned in front of the recessed portion 42 (see A of FIG. 11).

A front side of the housing 40 is slightly narrower than a rear side, and a protruding portion 46 and a claw 47 are formed in a protruding manner on each of two side surfaces 40a, 40b of the narrow part. The protruding portion 46 and the claw 47 are arranged in an up-down direction, and the protruding portion 46 is positioned above the claw 47. Additionally, a front half portion 40c of a lower surface of the narrow part of the housing 40 is more recessed than a rear half portion 40d, or in other words, the front half portion 40c is one step higher than the rear half portion 40d.

The retainer 60 is formed from a bottom plate portion 61, the front plate portion 62, two side plate portions 63, 64, and a rear block portion 65. A large number of insertion holes 66 are formed in the front plate portion 62 in an arrangement corresponding to the accommodating holes 41 of the housing 40. An opening 67 is formed in the bottom plate portion 61, the opening 67 having a size that allows the rear half portion 40d on the lower surface of the narrow part of the housing 40 to enter. The rear block portion 65 is positioned on the bottom plate portion 61, on a rear side relative to the opening 67, and has a shape that fits in the recessed portion 42 of the housing 40.

A large number of rectangular holes 68 are formed in the rear block portion 65 in a manner penetrating in the front-back direction and in a manner corresponding to the accommodating holes 41 on the lower row of the housing 40, and a protruding portion 69 is formed in a protruding manner on a front end of a lower surface inside each rectangular hole 68. The protruding portion 69 is formed in a manner coupled with one of two side surfaces inside the rectangular hole 68 while being spaced apart by a small gap 71 from the other. The gap 71 is at a position corresponding to the narrow groove 45 formed in the accommodating hole 41 of the housing 40.

A large number of protruding portions 72 are formed in a protruding manner on a front end of an upper surface of the rear block portion 65, in a manner corresponding to a large number of accommodating holes 41 on the upper row of the housing 40. A left-right width of the protruding portion 72 is smaller than a left-right width of the accommodating hole 41, and the protruding portion 72 is formed to be positioned at a center in the left-right width of the accommodating hole 41.

On each of the side plate portions 63, 64 that are coupled with the front plate portion 62 and the bottom plate portion 61 and that sandwich the rear block portion 65 from left and right, two cutouts 73, 74 are formed extending from a rear end to near a front end while being parallel to each other and parallel to the bottom plate portion 61. A long piece 75 positioned between the cutouts 73, 74 is slightly thin in thickness, and an outer surface of the long piece 75 is at a position more recessed than an outer surface of the side plate portion 63, 64, and a claw portion 76 that protrudes inward is formed at a lower end of an inner surface (see FIG. 13 described later).

FIG. 5 shows the terminal 50 that is attached to an end of the electric wire 80, and the terminal 50 includes the box-shaped portion 51, a core wire barrel portion 52, and a covering barrel portion 53. The core wire barrel portion 52 is connected to a core wire 81 of the electric wire 80 by crimping the core wire 81, and the covering barrel portion 53 is fixed to the electric wire 80 by crimping a cover 82 of the electric wire 80.

The box-shaped portion 51 is a part where a mating terminal (pin terminal) of a mating connector is to be inserted and connected, and a box-shaped outer shape is formed by bending a metal plate, and an elastic contact piece 54 that is to contact the mating terminal is provided inside. A cutout 55 is formed by cutting out a middle part, in a longitudinal direction (axial direction of the terminal 50), of an upper plate portion 51a forming an upper surface of the box-shaped portion 51, and a step portion 56 is formed on the upper plate portion 51a by the cutout 55. Additionally, in the present disclosure, of the upper plate portion 51a, a distal end side will be referred to also as a "first upper plate portion 51a1", and a core wire barrel portion 52 side as a "second upper plate portion 51a2". In the present example, the first upper plate portion 51a1 is provided at a position that is slightly higher than the second upper plate portion 51a2.

FIGS. 6 and 7 show a distal end part of the box-shaped portion of the terminal 50, and A of FIG. 6 is a top view seen from the first upper plate portion 51a1 side, and B of FIG. 6 is a perspective view seen from a projecting portion 560 side. A of FIG. 7 is a right side view of the distal end part of the terminal shown in A of FIG. 6, B of FIG. 7 is a left side view thereof, and C of FIG. 7 is a D-D cross-sectional view thereof. The projecting portion 560 is formed on an insertion direction side of the box-shaped portion 51, or in other words, the first upper plate portion 51a1 side of the step portion 56. The projecting portion 560 is a part of the step portion 56, and is provided in a manner protruding in an opposite direction (+y direction in FIG. 6) from the insertion direction (-y direction in FIG. 6) of the box-shaped portion 51. In the present example, the projecting portion 560 includes a first projecting portion 561 and a second projecting portion 562.

In a flat plate state before bending, the first projecting portion 561 is an extending portion where a first extending portion 561a and a second extending portion 561b are joined in an L-shape. One end portion of the first extending portion 561a is joined to an end portion of the first upper plate portion 51a1 in a width direction (x-axis direction). With respect to the joint part, an other end portion of the first extending portion 561a is bent to face downward (in a +z direction). With respect to a joint part between the first extending portion 561a and the second extending portion 561b, an other end of the second extending portion 561b is bent toward a side plate portion 51b (in a +x direction).

The second projecting portion 562 is formed in a manner protruding from an end portion of the first upper plate portion 51a1 in the axial direction of the terminal 50 toward the second upper plate portion 51a2 (in the +y direction in FIG. 6) in the axial direction of the terminal 50. As shown in FIG. 7, in the present example, the first projecting portion 561 and the second projecting portion 562 are provided next to each other in the up-down direction (z-axis direction in FIG. 7), and the second projecting portion 562 is formed to be longer than the first projecting portion 561 in the axial direction of the terminal 50. In other words, a length of protrusion of the second projecting portion 562 from the first upper plate portion 51a1 (length of protrusion in the +y direction in FIG. 6) is greater than a length of protrusion of the first projecting portion 561 in the same direction. With the first projecting portion 561, one end of the first extending portion 561a is fixed to the first upper plate portion 51a1, and one end of the second extending portion 561b is made a free end to achieve a cantilever shape. According to such a structure, a distal end of the second extending portion 561b is capable of being displaced in the axial direction of the terminal 50 (y-axis direction). When a force to pull out the terminal 50 is applied, the second extending portion 561b comes into contact with the protrusion 44, and the second extending portion 561b is displaced toward a distal end in the axial direction of the terminal 50. The second projecting portion 562 is not easily displaced like the second extending portion 561b. That is, the second projecting portion 562 is more rigid in the axial direction than the second extending portion 561b. Accordingly, engagement between the second projecting portion 562 and a recessed portion 44a described later is maintained, and connection reliability can be increased.

On a rear end side part of one side plate portion 51b of the box-shaped portion 51, the side plate portion 51b is extended upward to form a guide piece 57, and an extended piece 58 that is bent and extended from rear ends of the guide piece 57 and the side plate portion 51b is further formed. The extended piece 58 is positioned to form a rear end of the box-shaped portion 51. An upper end part of the guide piece 57 is at a position higher than the extended piece 58. As shown in FIG. 5, in the present example, the extended piece 58 is formed from a third extending portion 58a, a fourth extending portion 58b joined to the third extending portion 58a, and a fifth extending portion 58c joined to the fourth extending portion 58b. In a flat plate state before bending, the third extending portion 58a, the fourth extending portion 58b, and the fifth extending portion 58c are joined in an L-shape. One end of the third extending portion 58a is joined to a lower part of the guide piece 57, and the joint part is bent, and an other end of the third extending portion 58a extends toward the side plate portion 51b not including the guide piece 57 (in a -x direction). A joint part of the fourth extending portion 58b to the third extending portion 58a is bent, and an other end of the fourth extending portion 58b, a facing direction of which is changed due to the L-shape, extends upward (in a -z direction). A joint part of the fifth extending portion 58c to the fourth extending portion 58b is bent, and an other end of the fifth extending portion 58c extends toward the side plate portion 51b including the guide piece (in the +x direction). The other end of the fifth extending portion 58c extends up to a position where a part thereof is inserted in a cutout 57a formed in the guide piece 57. One end of the extended piece 58 is fixed to the guide piece 57, and an other end is a free end. That is, the extended piece 58 has a cantilever shape that is fixed to the guide piece 57. According to such a structure, the extended piece 58 forms a box shape. Because a distal end of the fifth extending portion 58c is inserted in the cutout 57a, the guide piece 57 restricts displacement of the extended piece 58 toward the upper plate portion 51a.

The connector 1 is assembled by first attaching the retainer 60 to the housing 40, and then, attaching the terminal 50 to which the electric wire 80 is connected. In the following, assembly of the connector 1 will be described with reference to FIGS. 8 to 13. Additionally, in FIGS. 8 to 13, illustration of the terminals 50 and the electric wires 80 is simplified, and only one terminal 50 to which the electric wire 80 is connected is shown, as in FIGS. 3 and 4.

As shown in FIG. 8, the retainer 60 is attached to the housing 40. The retainer 60 is attached to the housing 40 from a lower surface side of the housing 40, and the rear block portion 65 of the retainer 60 is inserted into the recessed portion 42 of the housing 40 (see FIGS. 10 and 11). The front plate portion 62 of the retainer 60 is positioned to cover a front surface of the housing 40. In this state, the protruding portions 46 formed on the side surfaces 40a, 40b of the housing 40 enter into the cutouts 73 to be positioned inside the cutouts 73 that are the cutouts positioned at higher positions among the cutouts 73, 74 formed in the side plate portions 63, 64 of the retainer 60, and the side plate portions 63, 64 are caught by the protruding portions 46, and the retainer 60 is thus retained and positioned relative to the housing 40 (see A and B of FIG. 13).

A to C of FIG. 10 show, in an A-A cross-sectional view in FIG. 9, a process in which the terminal 50 is inserted and accommodated into the accommodating hole 41 of the housing 40 to reach a secondary locking state, and A to C of FIG. 11 show, in a B-B cross-sectional view in FIG. 9, the same process as that in A to C of FIG. 10. A description will be given below.

<A of FIG. 10, A of FIG. 11>

A state is shown where the box-shaped portion 51 of the terminal 50 is being inserted into the accommodating hole 41 from a rear end of the housing 40, in a state where the retainer 60 is positioned at a position shown in FIG. 8 and A and B of FIG. 13, or in other words, in a state where the retainer 60 is at a first position. Because the retainer 60 is at the first position and is retracted, the retainer 60 does not interfere with insertion of the box-shaped portion 51, and more specifically, the protruding portions 72 (69) provided on the retainer 60 do not interfere with insertion of the box-shaped portion 51.

<B of FIG. 10, B of FIG. 11>

A state is shown where the box-shaped portion 51 is further inserted until the box-shaped portion 51 abuts, at the retainer 60 on a front end side of both side surfaces of the accommodating hole 41, a restriction portion 48 that is formed protruding toward a facing side surface. The box-shaped portion 51 is pushed by the free end 43a of the pressing piece 43 that is provided protruding from the accommodating hole 41, to be displaced in an intersecting direction intersecting with the insertion direction (in the present example, downward in a direction orthogonal to the insertion direction), and the protrusion 44 protruding from the accommodating hole 41 enters the cutout 55 provided in the box-shaped portion 51. Furthermore, a facing surface of the box-shaped portion 51 facing the lower surface 41b where the protrusion 44 of the accommodating hole 41 is formed is abutted against the lower surface 41b. Accordingly, the projecting portion 560 formed on the step portion 56 is caught by the protrusion 44, and the box-shaped portion 51 is retained. Retention of the projecting portion 560 includes two types of retention, namely, first retention and second retention. A of FIG. 12 is an enlarged view of a distal end part of the terminal in C of FIG. 10, and B of FIG. 12 is an enlarged view of the distal end part of the terminal in C of FIG. 11. The second extending portion 561b of the first projecting portion 561 is caught by the protrusion 44, and first retention is achieved. The second projecting portion 562 engages with the recessed portion 44a provided on the protrusion 44, and second retention is achieved. First retention may also be achieved by the second extending portion 561b and a part of the second projecting portion 562 being caught by the protrusion 44. Additionally, the guide piece 57 provided on the box-shaped portion 51 enters the groove 45 provided on the accommodating hole 41.

Furthermore, when the box-shaped portion 51 is displaced in the above manner, the protruding portion 72 (69) of the retainer 60 protruding on an extension of the accommodating hole 41 is positioned on the rear end of the box-shaped portion 51, or in other words, behind the extended piece 58 of the box-shaped portion 51, and the rear end of the box-shaped portion 51 is caught by the protruding portion 72 (69) of the retainer 60 and the box-shaped portion 51 is retained.

As described above, in the present example, in a state where the terminal 50 is inserted in the accommodating hole 41 and accommodation of the box-shaped portion 51 of the terminal 50 in the accommodating hole 41 is completed and primary locking of the terminal 50 is achieved, the box-shaped portion 51 is doubly retained by the protrusion 44 and the protruding portion 72 (69). First retention and second retention described above are performed by the protrusion 44. Additionally, the guide 57 of the box-shaped portion 51 inserted in the groove 45 is caught by a front surface of the rear block portion 65 of the retainer 60 to achieve retention.

<C of FIG. 10, C of FIG. 11>

The retainer 60 attached to the housing 40 is capable of being replaced in the intersecting direction intersecting with the insertion direction of the box-shaped portion 51 into the accommodating hole 41 (in the present example, the up-down direction that is also the direction orthogonal to the insertion direction), and a state is shown where the retainer 60 is further inserted into the housing 40 and the retainer 60 is displaced from first position to a second position.

When the retainer 60 is displaced in the above manner, a range in which the protruding portion 72 (69) of the retainer 60 overlaps the rear end of the box-shaped portion 51 of the terminal 50 is increased, or in other words, hooking between the protruding portion 72 (69) of the retainer 60 and the rear end of the box-shaped portion 51 is increased, and the terminal 50 is fully locked, or in other words, the secondary locking state is reached.

Additionally, C and D of FIG. 13 show a state where the retainer 60 is displaced to the second position, and the claw portion 76 provided on an inner surface of the long piece 75 of the retainer 60 moves over the claw 47 of the housing 40 to be positioned above the claw 47, and the retainer 60 is thus retained and positioned at the second position. The rear half portion 40d on the lower surface of the narrow part of the housing 40 is fitted in the opening 67 of the bottom plate portion 61 of the retainer 60. The insertion hole 66 provided in the front plate portion 62 of the retainer 60 is at a position corresponding to a front end opening of the box-shaped portion 51 of the terminal 50, and allows insertion of a mating terminal into the box-shaped portion 51.

With the connector 1 of the present disclosure described above, in the primary locking state, the box-shaped portion 51 is pushed by the pressing piece 43 of the housing 40 to be pressed against an inner surface (lower surface 41b) of the accommodating hole 41, and the terminal 50 maintains a stable posture without rattling, and retention is also achieved by the projecting portion 560 formed on the step portion 56 of the box-shaped portion 51 being caught by the protrusion 44. Retention is achieved by the step portion 56 and the rear end (extended piece 58) of the box-shaped portion 51 being caught by the protrusion 44 of the housing 40 and the protruding portion 72 (69) of the retainer 60, and thus, locking and retention are doubly achieved by the protrusion 44 and the protruding portion 72 (69). With respect to retention of the projecting portion 560, first retention where the second extending portion 561b of the first projecting portion 561 is caught by the protrusion 44, and second retention where the second projecting portion 562 engages with the recessed portion 44a provided on the protrusion 44 are performed.

Recently, there is a demand to further reduce the size of a connector, and a terminal that is an internal component of the connector is becoming more and more miniaturized. However, from the standpoint of connection reliability, the same performance as in a conventional case is desired to be maintained with respect to holding force of primary locking and secondary locking of the terminal.

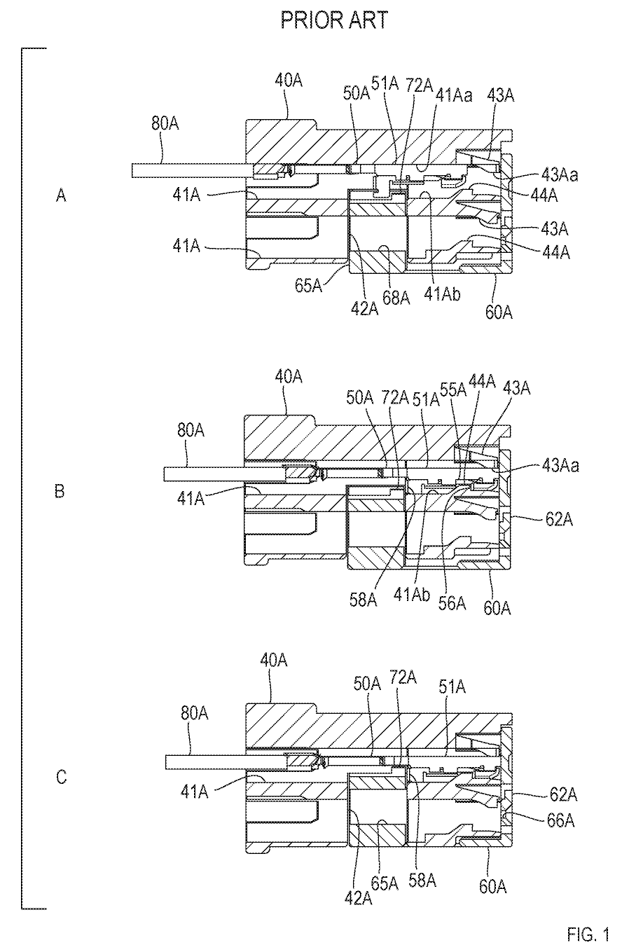

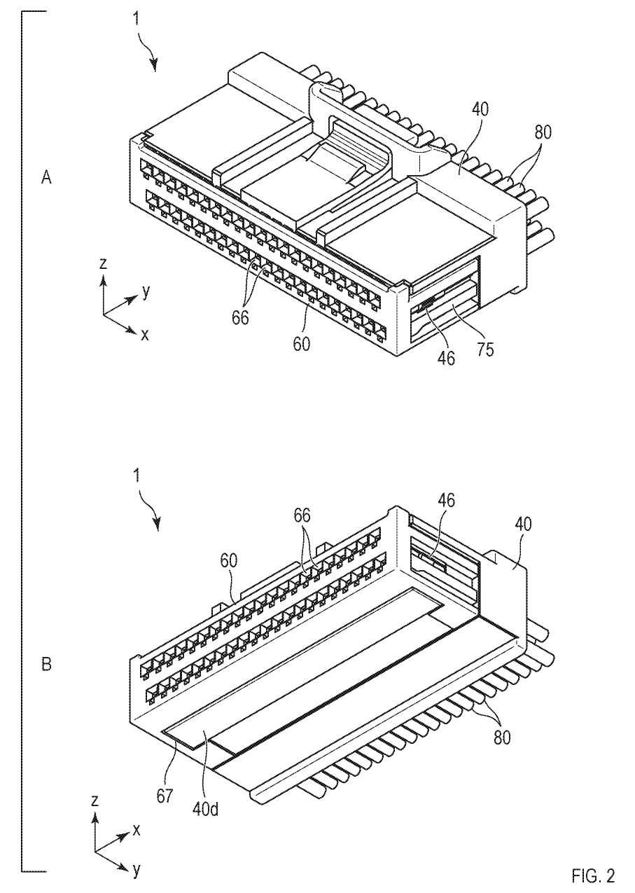

In this regard, the structure of the conventional connector described above has a problem that, when the terminal is pulled while being vertically shaken, a locked posture of the terminal does not remain stable in relation to a locking portion and desirable terminal holding force is not obtained, and the terminal is pulled out. More specifically, there is a problem that, in a case where the electric wire 80A of Patent Literature 1 is swung downward, for example, locking by the protrusion 44A is released. That is, in the state as shown in FIG. 1, primary locking is maintained, but locking at the protrusion 44A is possibly released, and there is a problem that connection reliability is insufficient. This is a problem that is grasped in the case as described above where a structure where a secondary locking part supplements the role of primary locking is adopted and further miniaturization is achieved, and this can be said to be a new problem that is not grasped in relation to the conventional example.

With the connector 1 of the present embodiment, even when removal is performed in a vertically shaken state, the second extending portion 561b of the first projecting portion 561 is locked to the protrusion 44, and also, the second projecting portion 562 is caught by the recessed portion 44a, and thus, the locked posture of the terminal can be stabilized, and stable terminal holding force can be secured even for a miniaturized terminal.

Furthermore, in the state of primary locking of the connector 1 of the present disclosure, the box-shaped portion 51 of the terminal 50 is locked at two positions, namely, the protrusion 44 and the protruding portion 72 (69), and thus, even if the electric wire 80 is swung and a force that tilts the terminal 50 is applied to the terminal 50, for example, the terminal 50 can be prevented from being pulled out. FIGS. 14 and 15 show such a state, and FIG. 14 shows a state where locking is maintained by the protruding portion 72 of the retainer 60 even when the electric wire 80 is swung downward and locking by the protrusion 44 is released. FIG. 15 shows a state where locking is maintained by the protrusion 44 of the housing 40 even when the electric wire 80 is swung upward and locking by the protruding portion 72 of the retainer 60 is released.

What is claimed is:

1. A connector comprising a terminal that includes a box-shaped portion to which a mating terminal is inserted and connected and that is attached to an end of an electric wire, a housing that includes an accommodating hole for accommodating the box-shaped portion, and a retainer that is capable of being at a first position and a second position by being attached to the housing in a manner capable of being displaced in an intersecting direction intersecting with an insertion direction of the box-shaped portion into the accommodating hole, wherein
when inner surfaces of the accommodating hole of the housing that face each other are given as an upper surface and a lower surface, a pressing piece having a cantilever shape is formed on the upper surface in a manner protruding toward the lower surface, and a protrusion is formed on the lower surface in a manner protruding toward the upper surface,
the retainer includes a protruding portion that protrudes in the intersecting direction, on an extension of the accommodating hole, and
when the retainer is at the first position, the box-shaped portion is allowed to be inserted into the accommodating hole, and the box-shaped portion inserted in the accommodating hole is pushed by the pressing piece and displaced in the intersecting direction so that a primary locking state is reached due to a projecting portion that is a part of a step portion formed on the box-shaped portion and that is provided on the insertion direction side of the step portion in a manner protruding in an opposite direction from the insertion direction being caught by the protrusion and engaged and retained by a recessed portion formed on the protrusion and a rear end of the box-shaped portion being caught and retained by the protruding portion.

2. The connector according to claim 1, wherein, when the retainer is displaced from the first position to the second position, hooking between the protruding portion and the rear end of the box-shaped portion is increased, and a secondary locking state is reached.

3. The connector according to claim 1, wherein
the projecting portion includes a first projecting portion, and a second projecting portion that is provided next to the first projecting portion and that is longer than the first projecting portion, and
retention of the projecting portion includes
first retention where at least the first projecting portion is caught by the protrusion, and
second retention where the second projecting portion is engaged with the recessed portion.

4. The connector according to claim 3, wherein, due to displacement of the box-shaped portion in the intersecting direction, a facing surface of the box-shaped portion facing the lower surface of the accommodating hole is abutted against the lower surface.

5. The connector according to claim 3, wherein a free end, of the pressing piece, for pressing the box-shaped portion is positioned on a front end side of the accommodating hole, and the protrusion is positioned more to a rear end side of the accommodating hole than the free end.

6. The connector according to claim 4, wherein a free end, of the pressing piece, for pressing the box-shaped portion is positioned on a front end side of the accommodating hole, and the protrusion is positioned more to a rear end side of the accommodating hole than the free end.
